(19) United States
(12) Patent Application Publication
(10) Pub. No.: US 2019/0318605 A1
(43) Pub. Date: Oct. 17, 2019

(54) MONITORING AND MANAGEMENT OF POTABLE WATER INSTALLATION SYSTEMS

(71) Applicant: INTERNATIONAL BUSINESS MACHINES CORPORATION, Armonk, NY (US)

(72) Inventors: Vikas K. MANORIA, Bangalore (IN); Sivakumar AVKD, Visakhapatnam (IN); Vijay Chandra S. TELUKAPALLI, Bangalore (IN)

(21) Appl. No.: 15/955,093

(22) Filed: Apr. 17, 2018

(51) Int. Cl. G08B 21/18; G05D 7/06

(52) U.S. Cl. CPC G08B 21/182; G05B 15/02; G05D 7/0623

(57) ABSTRACT

Systems and methods for monitoring and managing potable water installations (PWIs) systems are disclosed. In embodiments, a computer-implemented method comprises: receiving, by a computing device, monitoring data from a PWI via a network; generating, by the computing device, misery factor data for misery factors including availability of water, quality of water and hygiene of the PWI, wherein the misery factor data is based on the monitoring data; assigning, by the computing device, weights to the misery factor data for each of the misery factors; calculating, by the computing device, a misery index based on the misery factor data, wherein the misery index is a number indicative of conditions at the PWI; and generating, by the computing device, an alarm based on the misery data.

### BACKGROUND

The present invention relates generally to point of use monitoring and, more particularly, to monitoring and management of Potable Water Installation (PWI) systems.

Water delivered to a point of consumption is called potable water if it meets certain water quality standards for human consumption. Different countries have different regulations for the safe supply and preservation of drinking water. In some places around the globe, potable water is made available to consumers through Potable Water Installation (PWI) systems or units at public and/or private facilities. In general, consumers' basic expectations of these PWI units center around availability, quality of water, and hygiene maintenance of the PWI. In general, PWI managers are concerned with PWI usage patterns, reduction of waste, water leakage, and damage to the PWI.

### SUMMARY

In an aspect of the invention, a computer-implemented method includes: receiving, by a computing device, monitoring data from a potable water installation (PWI) via a network; generating, by the computing device, misery factor data for misery factors including availability of water, quality of water and hygiene of the PWI, wherein the misery factor data is based on the monitoring data; assigning, by the computing device, weights to the misery factor data for each of the misery factors; calculating, by the computing device, a misery index based on the misery factor data, wherein the misery index is a number indicative of conditions at the

PWI; and generating, by the computing device, an alarm based on the misery data.

In another aspect of the invention, there is a computer program product for management of potable water installations (PWIs). The computer program product comprises a computer readable storage medium having program instructions embodied therewith. The program instructions are executable by a computing device to cause the computing device to: receive monitoring data from a remote potable water installation (PWI) via a network; generate misery factor data for one or more misery factors indicative of conditions at the remote PWI, wherein the misery factor data is based on the monitoring data; generate an alarm based on the misery data; and automatically initiate changes to the remote PWI via the network based on the alarm.

In another aspect of the invention, there is a system for management of potable water installations (PWIs). The system includes a CPU, a computer readable memory and a computer readable storage medium associated with a computing device; program instructions to receive monitoring data from a potable water installation (PWI) via a network, the monitoring data including sensor data and digital video data; program instructions to determining context data from the digital video data utilizing visual recognition techniques; program instructions to generate misery factor data for one or more misery factors indicative of conditions at the PWI, wherein the misery factor data is based on the monitoring data and the context data; and program instructions to calculate a misery index based on the misery factor data, wherein the misery index is a number indicative of conditions at the PWI, wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIG. 3 shows a flowchart of steps of a method in accordance with aspects of the invention.

FIG. 4 depicts an exemplary use scenario in accordance with aspects of the invention.

FIG. 5A is an enlarged exemplary display from FIG. 4, and is illustrative of steps of FIG. 3.

FIG. 5B is an enlarged exemplary display from FIG. 4, and is illustrative of steps of

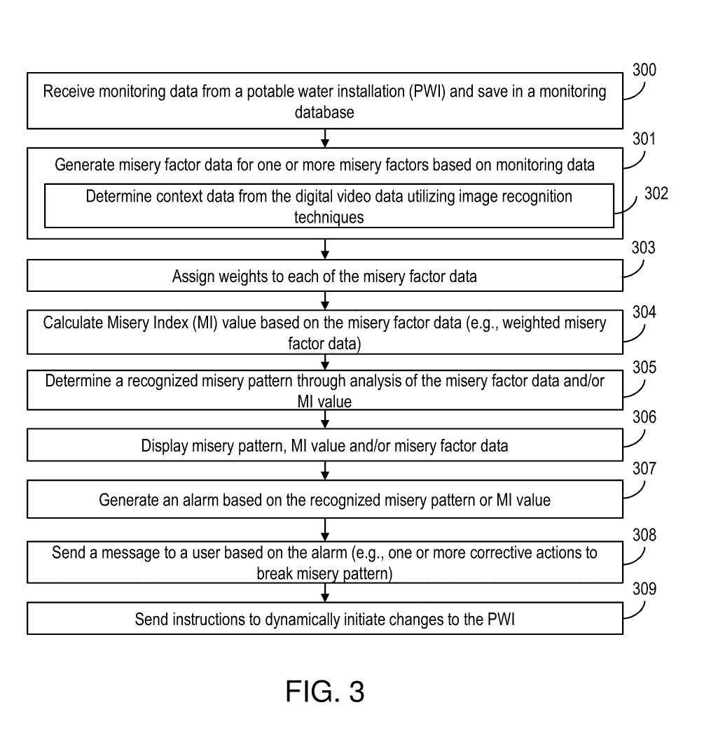

FIG. 3.

### DETAILED DESCRIPTION

The present invention relates generally to point of use monitoring and, more particularly, to monitoring and management of Potable Water Installation (PWI) systems. In embodiments, a system is provided for monitoring Potable Water Installation (PWI) units. In aspects, the system monitors a plurality of parameters including availability of water, quality of water, hygiene maintenance of PWI units, usage patterns, and intentional or unintentional damage (e.g., leakage) to PWI units, and uses the information to determine misery factor data and to calculate a Misery Index (MI) based on the misery factor data. The system may utilize visual information from cameras to determine cleanliness of a PWI, the number of people visiting the PWI and their usage patterns, intentional and unintentional water waste, asset theft, intentional and unintentional damage to PWI units and routine cleanliness processes, for example. A variety of point-of-use sensors may also be utilized to determine parameters of interest, including liquid level sensors, water quality sensors, leakage sensors and temperature sensors. In embodiments, the system generates proactive or reactive alerts based on recognized misery data patterns or the MI meeting threshold values. In aspects, the system automatically initiates remedial actions based on the alerts. In embodiments, the system sends the alerts to remote users in order to initiate manual remedial actions based on the alerts.

If consumers' expectations of a PWI are not met, the results may be disease, hardship and misery. Malfunctioning PWIs may effect public health, citizen welfare, tourism, consumers' trust in public facilities and a local government's reputation, for example. In such cases, consumers may look to alternative safe water sources. Bottled water is sold for public consumption in most parts of the world. Problems exist in that vendors, PWI unit care takes and officials may be incentivized to make money from bottled water. More specifically, there may be an incentive to “cheat” by creating misery among PWI unit consumers (e.g., by damaging or failing to maintain the PWI unit) in order to drive the consumers to buy bottled water instead of utilizing free water from the PWI unit. This situation has serious implications on public health, citizen welfare and tourism, and adversely impacts consumers' trust in public facilities and hurts the reputation of local governments.

Advantageously, embodiments of the present invention provide technical solutions to the problem of PWI unit maintenance and management, by providing a system that can simultaneously monitor multiple remote PWI units and recognize patterns in data indicative of deterioration of the PWI units. In implementations, the system performs an unconventional MI calculation, and utilizes the MI calculation to initiate alerts and/or automatic changes to a PWI unit to address potential or actual problems at the point-of-use. In aspects, Internet of Things (IoT) sensors and cameras located at PWI units are utilized to provide centralized cloud-based monitoring capabilities for multiple locations, including locations remote from population centers. In this way, any local incentive to “cheat” may be circumvented.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

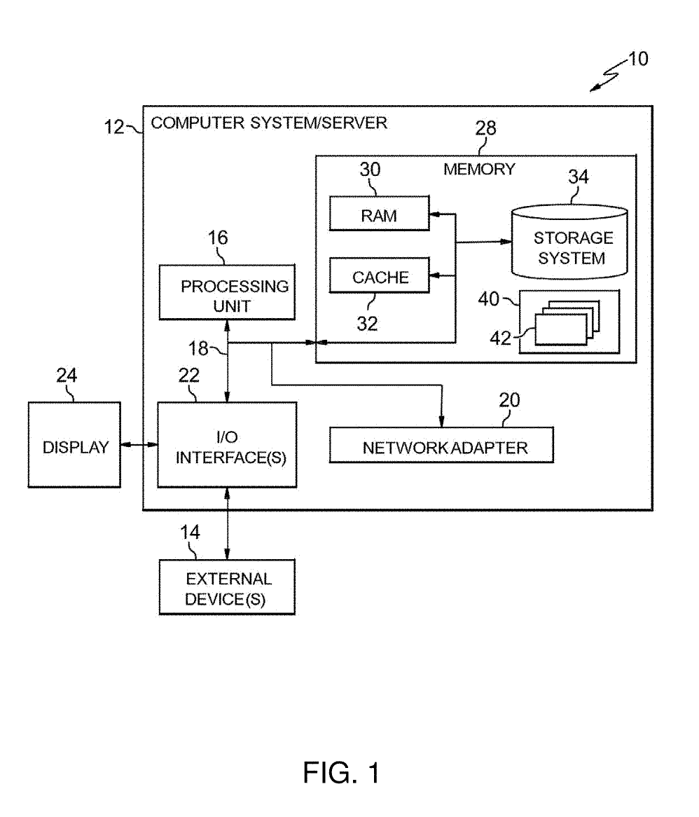

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

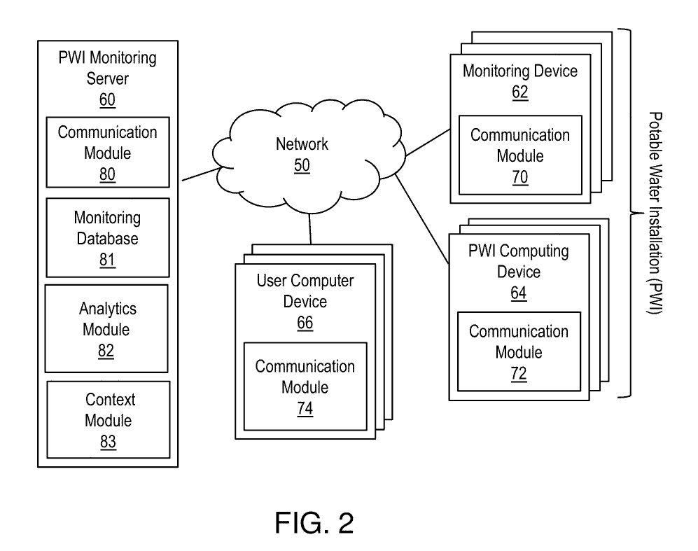

FIG. 2 shows an exemplary environment in accordance with aspects of the invention. The environment includes a network 50 connecting a Potable Water Installation (PWI) monitoring server 60 with one or more monitoring devices 62, one or more PWI computing devices 64 located at respective PWIs, and one or more user computer devices 66. The term PWI as used herein refers to a water supplying system comprised of at least a source of water intended to be potable, a distribution system enabling the distribution of the water to one or more consumers, such as through one or more faucets, and one or more monitoring devices 62 for monitoring conditions of the PWI. In embodiments the PWI's comprise one or more PWI computing devices 64, which may be in communication with on-site monitoring devices 62, either directly or through wireless communication channels.

The PWI monitoring server 60 may comprise a computer system 12 of FIG. 1, and may be connected to the network 50 via the network adapter 20 of FIG. 1. The PWI monitoring server 60 may be configured as a special purpose computing device that is part of a PWI management infrastructure. For example, the PWI monitoring server 60 may be a cloud-based server configured to receive monitoring data from monitoring devices 62 at a plurality of remote PWI locations, and communicate alerts regarding the PWIs to the user computer device 66 and/or PWI computing devices 64 located at the respective PWIs.

The network 50 may be any suitable communication network or combination of networks, such as a local area network (LAN), a general wide area network (WAN), and/or a public network (e.g., the Internet). The monitoring devices 62 may be in the form of one or more digital video cameras, sensors, or combinations thereof. In aspects, the monitoring devices 62 each include a communication module 70 configured to enable communication between the monitoring devices 62 and the PWI monitoring server 60 and/or or one or more of the PWI computing devices 64 via the network 50 (either directly or through wireless communication). Alternatively, a single communication module 70 may be utilized by multiple monitoring devices 62 to facilitate communication.

In embodiments, the PWI computing devices 64 comprise components of the computer system 12. The PWI computing devices 64 may be a laptop, desktop, tablet, or smartphone computing device, or combinations thereof. In embodiments the PWI computing devices 64 are in the form of special computing devices. For example, the PWI computing devices 64 may be special computing devices dedicated to the control and/or management of a PWI. In aspects, the PWI computing devices 64 each comprise a communication module 72 configured to enable communication between the PWI computing devices 64 and the PWI monitoring server 60 through the network 50, either directly or through wireless communication. Alternatively, a single communication module 72 may connect multiple PWI computing devices 64 to the PWI monitoring server 60 via the network 50.

Still referencing FIG. 2, in embodiments the user computer devices 66 comprise components of the computer system 12. The user computer devices 66 may be comprised of a laptop, desktop, tablet, or smartphone computing device, or combinations thereof. In embodiments, the user computer devices 66 each include a communications module 74 configured to enable communication between the respective user computer devices 66 and the PWI monitoring server 60 via the network 50. In aspects, the user computer devices include a display (e.g., display 24 of FIG. 1) configured to display information received from the PWI monitoring server 60 through the network 50.

Still referring to FIG. 2, the PWI monitoring server 60 may include one or more modules configured to perform one or more functions as described herein, with each module including one or more program modules (e.g., program module 42 of FIG. 1) executed by the PWI monitoring server 60. In embodiments, a communication module 80 of the PWI monitoring server 60 is configured to communicate with the communication modules 70, 72 and 74 of the respective monitoring devices 62, PWI computing devices 64 and user computer devices 66. In aspects, the communication module 80 is configured to receive monitoring data from the monitoring devices 62 and store the monitoring data in a monitoring database 81. The monitoring data may be in the form of sensor data, digital video data, and combinations thereof.

In embodiments, the PWI monitoring server 60 includes an analytics module 82 configure to analyze the monitoring data to generate misery factor data for one or more misery factors based on the monitoring data. The misery factors may comprise: availability of water, quality of water, and hygiene of the PWI at issue. In aspects, the analytics module 82 is configured to aggregate the monitoring data for a PWI by type of misery factor to produce aggregate monitoring data over time. The aggregated monitoring data may be saved in the monitoring database 81 and utilized by the analytics module 82 to determine the misery factor data. In embodiments, the analytics module 82 is configured to calculate a Misery Index (MI) based on the misery factor data. The term MI as used herein refers to a number indicative of overall conditions at the PWI (e.g., water availability+water quality+hygiene of the PWI). In aspects, the analytics module 82 is configured to generate one or more alarms based on the misery data or MI, and send the alarms to one or more remote computing devices (e.g., PWI computing device 64 or user computer device 66). In embodiments, the analytics module 82 is configured to send instructions to one or more monitoring devices 62 or PWI computing devices 64 to automatically initiate changes to a PWI system (e.g., automatically turn water off or refill a water reservoir). In aspects, the analytics module 82 is configured to initiate the display of analytics information to a user, either directly through a display (e.g. display 24 of FIG. 1) of the PWI monitoring server 60, or through a display interface of one or more of the PWI computing devices 64 and user computer devices 66.

In embodiments, the PWI monitoring server 60 includes a context module 83 configured to analyze digital video data for context with respect to one or more misery factors. In aspects, the context module 83 utilizes image recognition techniques to determine context data with respect to one or more misery factors. For example, the context module 83 may perform image recognition algorithms to detect water leaks at a PWI, hygiene maintenance events at the PWI (e.g., arrival of cleaning crew), vandalism of the PWI, physical damage to the PWI, or the like. In embodiments, the analytics module 82 is configure to analyze the context data from the context module 83 to generate misery data.

The quantity of devices and/or networks in the environment of FIG. 2 is not limited to what is shown in FIG. 2. In practice, the environment of the present invention may include additional devices and/or networks; fewer devices and/or networks; different devices and/or networks; or differently arranged devices and/or networks than illustrated in FIG. 2. Also, in some implementations, one or more of the devices of the environment of FIG. 2 may perform one or more functions described as being performed by another one or more of the devices of the environment. Devices of the environment of FIG. 2 may interconnect via wired connections, wireless connections, or a combination of wired and wireless connections.

FIG. 3 shows a flowchart of a method in accordance with aspects of the invention. Steps of the method of FIG. 3 may be performed in the environment illustrated in FIG. 2, and are described with reference to elements shown in FIG. 2.

At step 300, the PWI monitoring server 60 receives monitoring data from a PWI and saves the monitoring data in the monitoring database 81. In embodiments, the communication module 80 of the PWI monitoring server 60 receives monitoring data from one or more monitoring devices 62 on-site at the PWI. In aspects, the monitoring devices 62 are Internet of Things (IoT) devices in communication with the PWI monitoring server 60 through a wireless network connection. In other embodiments, one or more PWI computing device 64 on-site at a PWI obtain the monitoring data from one or more on-site monitoring devices 62 and pass the monitoring data along to the communication module 80 of the PWI monitoring server 60.

In embodiments the monitoring devices 62 utilized in accordance with step 300 comprise one or more sensors, digital video cameras, or combinations thereof. In aspects, the PWI monitoring server 60 receives monitoring data in the form of timestamped sensor data and timestamped digital video data. The sensor data may include water quality data from water qualities sensors. Data received in accordance with step 300 may include liquid level data from water level sensors, temperature data from temperature sensors, turbidity data from turbidity sensors, oxygen levels from oxygen level sensors, oxidation-reduction potential (ORP) data from ORP sensors, electrical conductivity data from electrical conductivity sensors, pH data from pH sensors, or other sensor data indicative of the availability or quality of water at a PWI. The sensor data and/or digital video data may be pre-recorded data or streaming data.

In embodiments, the PWI monitoring server 60 may aggregate the received monitoring data over a period of time to generate aggregated monitoring data. The PWI monitoring server 60 may receive the monitoring data either continuously or periodically, and may enable a user to configure timelines/periods for receiving monitoring data. For example, the PWI monitoring server 60 may be configured to selectively retrieve and/or receive monitoring data on an hourly, daily, weekly, or monthly schedule from a PWI.

At step 301, the PWI monitoring server 60 generates misery factor data for one or more misery factors based on the monitoring data received at step 300. In embodiments, the analytics module 82 of the PWI monitoring server 60 generates misery factor data for each of the following misery factors: availability of water, quality of water, and hygiene of the PWI. It should be understood that availability of water may constitute the availability of water to a consumer who is seeking to obtain potable water; the quality of the water may constitute the quality of the water with respect to predetermined criteria for water to qualify as potable water based on local rules/laws/accepted practice; and the hygiene of the PWI may constitute the cleanliness of the PWI generally, or the cleanliness of faucets, water tanks, and/or other components of the PWI. The misery factor data may comprise aggregated misery factor data from aggregated misery monitoring data.

At substep step 302, the context module 83 of the PWI monitoring server 60 analyzes digital video data received at step 300 for context data, wherein the context data relates to one or more misery factors such as: availability of water, quality of water, and hygiene of the PWI. For example, the context module 83 may perform image recognition algorithms to detect water leaks at a PWI, hygiene maintenance events at the PWI (e.g., arrival of cleaning crew), vandalism of the PWI (e.g., deliberate contamination of a water supply), physical damage to the PWI, or the like.

Optionally, at step 303, the PWI monitoring server 60 assigns weights to misery factor data determined at step 301. For example, the PWI monitoring server 60 may assign different weightages to misery factor data related to each of the following misery factors: availability of water, quality of water, and hygiene of the PWI. Weights may be predetermined, and may be automatically applied by the PWI monitoring server 60 based on a look-up table of weights per PWI location or PWI type. For example, at a first type of PWI, the hygiene of the PWI may have little effect on consumers' desire to access potable water from the PWI, in which case an appropriate low weight will be assigned to misery factor data associated with hygiene of the PWI.

At step 304, the PWI monitoring server 60 calculates a Misery Index (MI) based on the misery factor data generated at step 301 or the weighted misery factor data of step 303. In embodiments, the analytics module 82 of the PWI monitoring server 60 calculates the MI and saves the MI in the monitoring database 81. As noted above, the term MI as used herein refers to a number indicative of overall conditions at the PWI. The MI may be calculated based on misery data for a particular time period. In aspects, the MI is calculated periodically based on periodically received (aggregated) misery data. In exemplary embodiments, the analytics module 82 utilizes the following formula to calculate MI for each PWI, where X, Y and Z represent weight factors:

MI=(Availability of Water*X)+(Quality of Water*Y)+(Hygiene of PWI*Z).

In such embodiments, the MI is calculated based on three misery factors or parameters. In an ideal situation, the value of MI is zero (0), with the index value increasing up to 100 as the presence of misery factors increases. In this example, irrespective of weights assigned to X, Y and Z , their total must be 100. In other words, X+Y+Z=100. In one example, Availability of Water is assigned a weight of 30, Quality of Water is assigned a weight of 40 and Hygiene is assigned a weight of 30, for a total of 100.

The Availability of Water can be in the range of 0-1. The Availability of Water may be calculated based on the aggregate of values associated with liquid level and leakage IoT sensor data, as well as context data such as usage patterns and wastage patterns determined from digital video camera data. For example, the analytics module 82 may determine that water availability problems for the next hour at a PWI considering the usage pattern and leakage of water at the PWI will be zero, with the value increasing as problems in availability of water arise. A numeric value associated with the Quality of Water can be in the range of 0-1. The Quality of Water may be calculated based on the aggregate of values associated with water quality and temperature sensor data, and may be checked against local predetermined water quality benchmarks. Deviations from the predetermined benchmarks increase the value of the Quality of Water parameter proportionately. Hygiene of a PWI may be calculated based on the aggregate of values associated with cleanliness of the PWI, such as context data determined from digital video data. Such data may include, for example, data regarding cleanliness processes (cleaning events), visible litter/track, leakages, spills, and/or accidental or intentional asset damages. The presence of any cleanliness issues (e.g., cleaning event did not occur, litter is present, etc.) increases the value of the Hygiene of a PWI parameter proportionately.

At step 305, the PWI monitoring server 60 determines a recognized misery pattern through analysis of the misery factor data. In embodiments, the analytics module 82 of the PWI monitoring server 60 determines recognized misery patterns in accordance with step 305 and saves the misery patterns in the monitoring database 81. The PWI monitoring server 60 may determine recognized misery patterns from the misery factor data directly, or from MI values derived from the misery factor data. The analytics module 82 may recognize misery patterns based on predetermined triggering events in a look-up table. For example, increasing MI values over time may be indicative of a pattern of deteriorating PWI conditions. In another example, misery factor data associated with Quality of Water may show an increase in water temperature over time, which may be recognized by the analytics module 82 as indicative of a pattern of deteriorating water quality at a PWI. In aspects, the PWI monitoring server 60 recognizes patterns in misery factor data for each of the following misery factors: Availability of Water; Quality of Water; and Hygiene of PWI. In aspects, the PWI monitoring server 60 compares MI values over time for the same PWI, along with other PWIs in the same geographic region, to determine if there is any regular trend or pattern in MI values. For example, one identified misery pattern may be “heavy use of the PWI between 8:00 to 11:00 AM leads to poor availability” and “poor hygiene situation at 12:00 PM”. A closer analysis of these patterns may lead to the determination that twenty two (22) trains are stopping at a railway platform adjacent the PWI between 8:00 and 11:00 AM every day. Accordingly, corrective actions (e.g., preventative measures) may be taken by users of the system to address this situation. See step 308 below.

At step 306, in embodiments, the PWI monitoring server 60 displays misery factor data, MI values and/or recognized misery pattern data to a user via a display (e.g., display 24 of FIG. 1). In embodiments, the PWI monitoring server 60 initiates display data to one or more PWI computing devices 64 and/or user computer devices 66. For example, an onsite PWI manager utilizes a PWI computing device 64 may obtain data in accordance with step 306 through a computer display of the PWI computing device 64. Alternatively, managers or other stakeholders located remote from the PWI may access data in accordance with step 306 through a computer display of their respective user computer devices 66.

At step 307, the PWI monitoring server 60 may generate an alarm based on a recognized misery pattern from step 305 or an MI value determined at step 304. In aspects, the analytics module 82 of the PWI monitoring server 60 generates the alarm. The alarm may be in the form of data, a text-based message, or a symbolic alarm (e.g., a red exclamation point), an audio alarm, or other form of communication.

At step 308, the PWI monitoring server 60 sends a message to a user based on the alarm generated at step 307. In embodiments, the analytics module 82 of the PWI monitoring server 60 sends the message to a user of the PWI monitoring server 60 through a display of the device (e.g., display 24 of FIG. 1). Alternatively, the analytics module 82 may send the message to one or more remote users, such as through one or more PWI computing devices 64 and/or user computer devices 66 via the network 50. The message may be in the form of a text-based message or may be in the form of a symbolic communication such as a graphical representation of a recognized misery pattern or a link to a website presenting information regarding a status of the PWI. In embodiments, the message indicates corrective measures that need to be taken based on the alarm of step 307. In aspects, the PWI monitoring server 60 searches a database for appropriate solution steps and any sequence of actions (e.g., corrective actions) mapped to an alarm of step 307, and presents a message to a user based on the solution steps and/or sequence of actions. For example, for “heavy-usage of a PWI” pattern, the suggested steps may be: (1) refill water when availability value is 15 (at 11:00 AM), and (2) clean at PWI once hygiene score reaches 10 (at 9:00 AM).

At step 309, the PWI monitoring server 60 sends instructions to dynamically initiate changes to one or more components of the PWI. In embodiments, the analytics module 82 of the PWI monitoring server 60 sends instructions to one or more of the monitoring devices 62 and/or one or more of the PWI computing devices 64 at a PWI. In aspects, the analytics module 82 may send the instructions to individual IoT enabled components of the PWI, such as IoT enabled faucets, water control valves, or the like, in order to automatically initiate changes to the on-site PWI system. For example, instructions from the PWI monitoring server 60 may cause a water control valve to close in order to shut off water at the PWI in the case of a water leak. In another example, instructions from the PWI monitoring server 60 may cause a water control valve to open to refill a water reservoir on-site at a PWI. Other automated functions may be implemented via instructions from the PWI monitoring server 60, and the invention is not limited by the examples discussed herein.

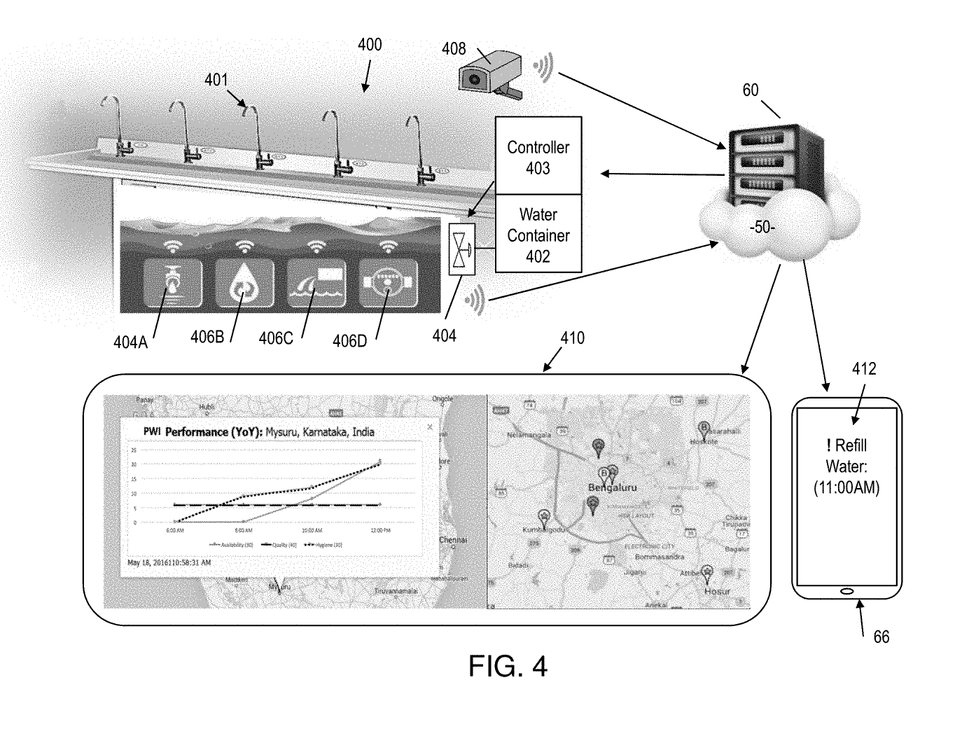

FIG. 4 depicts an exemplary use scenario in accordance with aspects of the invention. Steps illustrated in FIG. 4 may be performed in the environment illustrated in FIG. 2, and in accordance with the methods of FIG. 3.

FIG. 4 illustrates a cloud-based PWI monitoring server 60 for monitoring a remote PWI 400. PWI 400 is shown with a plurality of faucets 401 configured to provide potable water from a water source, such as a water container 402. PWI 400 is also shown with a controller 403 (e.g., a PWI computing device 64) configured to control one or more components of the PWI 400, such as a water control valve 404. In this example, sensor data from IoT sensors 406A-406D is sent wirelessly on a periodic basis to the PWI monitoring server 60 via the internet (network 50). Sensors 406A-406D may comprise any combination of PWI sensors, such as temperature sensors, turbidity sensors, oxygen sensors, pH sensors, conductivity sensors, oxidation-reduction sensors, water level sensors, or the like. In this example, digital video data from an IoT digital video camera 408 monitoring the PWI 400 is sent wirelessly on a periodic basis to the PWI monitoring server 60 via the internet (network 50), in accordance with step 300 of FIG. 3.

In accordance with the example of FIG. 4, the PWI monitoring server 60 generates misery factor data for the misery factors of: availability of water, quality of water, and hygiene of the PWI 400 in accordance with step 301 of FIG. 3, and assigns weights to each factor based on predetermined weights for PWI 400, in accordance with substep 302. The PWI monitoring server 60 utilizes the weighted misery data to calculate MI values over time for the PWI 400 in accordance with step 304. Additionally, the PWI monitoring server 60 analyzes the misery data and MI values to determine recognized misery patterns.

In the example of FIG. 4, the PWI monitoring server 60 recognizes an increase in numbers indicative of hygiene deterioration and an increase in numbers indicative of a deterioration in the availability of water. The PWI monitoring server 60 then displays misery factor data to a user via a computer display 410 in accordance with step 306 of FIG. 3. The PWI monitoring server 60 generates an alert in accordance with step 307 based on the misery data indicating that the availability of water at the PWI 400 has fallen below a predetermined threshold value. In this example, the PWI monitoring server 60 then sends a message 412 to the remote user computer device 66 based on the alert. The alert is in the form of a text message 412 stating “! Refill Water (11:00 AM)”, indicating that a stakeholder or manager of the PWI should refill the water container 402 of the PWI 400. Alternatively, the PWI monitoring server 60 dynamically initiates corrective actions at the PWI 400 based on the alert in accordance with step 309 of FIG. 3. In this example, the PWI monitoring server 60 sends instructions to the controller 403 (e.g., PWI computing device 64) that cause the controller 403 to automatically open the valve 404 of the water container 402 for a predetermined amount of time to refill the water container 402 from a water source (not shown). Accordingly, the PWI monitoring server 60 may dynamically initiate corrective actions at the remote PWI 400 to address the alert.

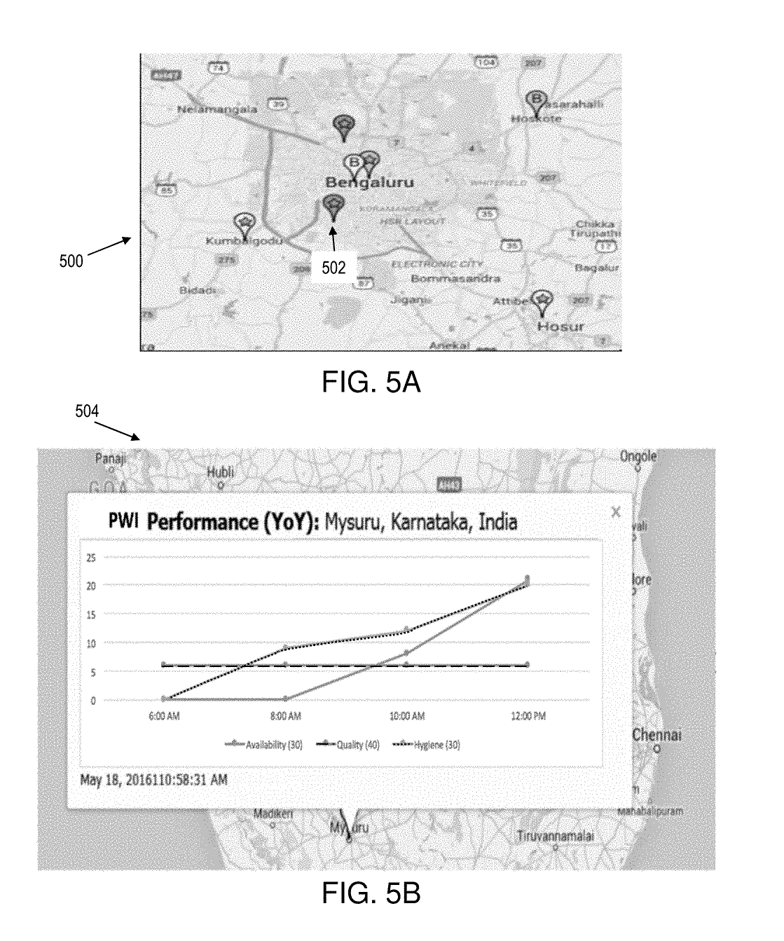

FIG. 5A is an enlarged exemplary display from FIG. 4, and is illustrative of steps of FIG. 3. In this example, the display 500 is in the form of a map showing symbolic data 502 indicative of different status levels associated with respective PWIs. In this example, a combination of symbols and colors is utilized to depict different status categories of the PWIs. Any combination of colors and symbols may be utilized in accordance with method steps of the present invention. For example, green may indicate that conditions at a PWI are good, yellow may indicated that conditions at a PWI are deteriorating, and red may indicate that conditions at a PWI are poor.

FIG. 5B is an enlarged exemplary display from FIG. 4, and is illustrative of steps of FIG. 3. In this example, the display 504 is in the form of a graph showing misery patterns determined by the PWI monitoring server 60. In this example, the graphs shows that at 8:00 AM water availability and hygiene started to deteriorate, indicating, for example, water leakage and/or an increase in use of the PWI by consumers. It should be understood that the displays 500 and 504 shown herein are merely illustrative examples of the types of informational displays that may be utilized in accordance with embodiments of the invention. The displays 500 and 504 as shown are not meant to be limiting.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still another embodiment, the invention provides a computer-implemented method for monitoring PWI systems. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, monitoring data from a potable water installation (PWI) via a network;
generating, by the computing device, misery factor data for misery factors including availability of water, quality of water and hygiene of the PWI, wherein the misery factor data is based on the monitoring data;
assigning, by the computing device, weights to the misery factor data for each of the misery factors;
calculating, by the computing device, a misery index based on the misery factor data, wherein the misery index is a number indicative of conditions at the PWI; and
generating, by the computing device, an alarm based on the misery data.

2. The method of claim 1, wherein the generating the alarm comprises generating the alarm indicating that the misery index meets or exceeds a predetermined threshold value.

3. The method of claim 1, further comprising determining a recognized misery pattern based on an analysis of the misery data, wherein the generating the alarm comprises generating the alarm based on the recognized misery pattern.

4. The method of claim 1, further comprising sending instructions to a controller of the PWI to dynamically initiate changes to the PWI via the network.

5. The method of claim 4, wherein the instructions comprise instructions to automatically shut down a flow of water within the PWI or automatically refill one or more water storage containers at the PWI.

6. The method of claim 1, wherein the receiving the monitoring data comprises receiving timestamped sensor data and timestamped digital video data.

7. The method of claim 6, further comprising determining context data from the timestamped digital video data utilizing visual recognition techniques, wherein aggregating the monitoring data includes aggregating the context data.

8. A computer program product for management of potable water installations (PWIs) the computer program product comprising a computer readable storage medium having program instructions embodied therewith, the program instructions executable by a computing device to cause the computing device to:
receive monitoring data from a remote potable water installation (PWI) via a network;
generate misery factor data for one or more misery factors indicative of conditions at the remote PWI, wherein the misery factor data is based on the monitoring data;
generate an alarm based on the misery data; and
automatically initiate changes to the remote PWI via the network based on the alarm.

9. The computer program product of claim 8, wherein the one or more misery factors comprise availability of water, quality of the water, and hygiene of the PWI.

10. The computer program product of claim 8, wherein the generating the alarm comprises generating the alarm indicating that the misery index meets or exceeds a predetermined threshold value.

11. The computer program product of claim 8, further comprising determining a recognized misery pattern based on an analysis of the misery data, wherein the generating the alarm comprises generating the alarm based on the recognized misery pattern.

12. The computer program product of claim 8, wherein the changes to the remote PWI comprise automatically shutting down a flow of water within the PWI or automatically refilling one or more water storage containers at the PWI.

13. The computer program product of claim 8, wherein the receiving the monitoring data comprises receiving timestamped sensor data and timestamped digital video data.

14. The computer program product of claim 8, further comprising determining context data from the timestamped digital video data utilizing visual recognition techniques, wherein aggregating the monitoring data includes aggregating the context data.

15. A system for management of potable water installations (PWIs), comprising:
a CPU, a computer readable memory and a computer readable storage medium associated with a computing device;
program instructions to receive monitoring data from a potable water installation (PWI) via a network, the monitoring data including sensor data and digital video data;
program instructions to determining context data from the digital video data utilizing visual recognition techniques;
program instructions to generate misery factor data for one or more misery factors indicative of conditions at the PWI, wherein the misery factor data is based on the monitoring data and the context data; and
program instructions to calculate a misery index based on the misery factor data, wherein the misery index is a number indicative of conditions at the PWI,
wherein the program instructions are stored on the computer readable storage medium for execution by the CPU via the computer readable memory.

16. The system of claim 15, wherein the misery factors are selected from the group consisting of: availability of water, quality of the water, and hygiene of the PWI.

17. The system of claim 15, further comprising program instructions to generate an alarm based on one or both of the misery index and the misery factor data.

18. The system of claim 17, further comprising program instructions to determine a recognized misery pattern based on an analysis of the misery data, wherein the generating the alarm comprises generating the alarm based on the recognized misery pattern.

19. The system of claim 17, further comprising program instructions to dynamically initiate changes to the PWI via the network based on the alarm.

20. The system of claim 19, wherein the changes comprise automatically shutting down a flow of water within the PWI or automatically refilling one or more water storage containers at the PWI.
